(19) United States
(12) Patent Application Publication
(10) Pub. No.: US 2025/0105930 A1
(43) Pub. Date: Mar. 27, 2025

(54) DEVICES, SYSTEMS AND METHODS FOR MONITORING IN A LOCATION TRACKING ENVIRONMENT

(71) Applicant: Inovonics Wireless Corporation, Westminster, CO (US)

(72) Inventor: Eric S. Roth, Broomfield, CO (US)

(21) Appl. No.: 18/825,228

(22) Filed: Sep. 5, 2024

Related U.S. Application Data
(60) Provisional application No. 63/584,189, filed on Sep. 21, 2023.

(51) Int. Cl. H04B 17/27; H04B 17/21; H04B 17/318

(52) U.S. Cl. CPC H04B 17/27; H04B 17/21; H04B 17/318

(57) ABSTRACT

A device may include a communication interface and processing logic. The processing logic may be configured to receive messages from each of a number of locator devices. Each message may include a signal strength value associated with a test message transmitted by an other one of locator devices. The processing logic may also be configured to determine whether a current signal strength value received in a message from a first one of the plurality of locator devices is within a predetermined range associated with signal strength values included in messages received from the first locator device.

### RELATED APPLICATION

This application claims priority under 35 U.S.C. § 119 based on U.S. Provisional Application No. 63/584,189 filed Sep. 21, 2023, titled “Devices, Systems and Methods for Monitoring in a Location Tracking Environment,” the disclosure of which is hereby incorporated herein by reference in its entirety.

### BACKGROUND INFORMATION

A pendant, such as a location tracking pendant or a duress pendant, is typically worn around the neck of a person, around the wrist of the person or clipped to an article of clothing on the person, such as a belt or a shirt. The pendant may be used to track the location of the wearer of the pendant and may include one or more sensors to automatically detect an event (e.g., request for help, a fall, etc.). In some scenarios, the pendant also transmits a beacon signal at regular intervals to one or more receiving devices placed at fixed locations. The receiving devices are used to determine the approximate location of the person wearing the pendant at any given time.

For example, each receiving device may measure the received signal strength of the pendant's beacon and relay that information to a central monitoring device. The central monitoring device may then identify the receiving device that received the beacon signal having the greatest signal strength and determine that the person wearing the pendant is located closest to that receiving device. This process is repeated at periodic intervals to provide near real-time location information associated with people wearing pendants.

In environments which may include a large number of pendants and receiving devices, one or more of the receiving devices may become inoperative and/or the performance of the receiving device(s) may become compromised. Such issues may affect the ability of the central monitoring device to accurately detect the location of people wearing the pendants.

### BRIEF DESCRIPTION OF THE DRAWINGS

FIG. 1 illustrates an exemplary environment in which systems and methods described herein may be implemented;

FIG. 2 is a block diagram of components implemented in one or more of the elements of the environment of FIG. 1 in accordance with an exemplary implementation;

FIG. 3 is a block diagram of logic components included in the locators of FIG. 1 in accordance with an exemplary implementation;

FIG. 4 illustrates an exemplary table used to store beacon signal strength information associated with the environment of FIG. 1;

FIG. 5 is a block diagram of logic components included in the location determining system of FIG. 1 in accordance with an exemplary implementation;

FIG. 6 illustrates an exemplary table used to store signal strength information associated with test messages transmitted by the locators included in the environment of FIG. 1;

FIG. 7 is a flow diagram illustrating processing associated with the environment of FIG. 1 in accordance with exemplary implementations; and

FIG. 8 is a block diagram associated with an exemplary environment in which a locator device may become compromised in accordance with an exemplary implementation.

### DETAILED DESCRIPTION OF EMBODIMENTS

The following detailed description refers to the accompanying drawings. The same reference numbers in different drawings may identify the same or similar elements.

Implementations described herein provide devices, systems and methods for monitoring locator devices and determining whether the locator devices may be compromised or have other issues affecting their ability to provide accurate tracking information. In one implementation, a locator device that is used to monitor the location of pendants worn by users may transmit a test message at predetermined intervals. The test messages may be received by other locator devices. Each locator device that receives a test message from another locator device may determine a signal strength of the received test message and transmit the received signal strength information to a central monitoring device. In one implementation, the central monitoring device may receive signal strength values from each of the locator devices and determine whether a current signal strength value for a particular locator device is outside a predetermined range associated with other signal strength values associated with the particular locator device. The predetermined range may be based on, for example, the mean and/or standard deviation associated with the signal strengths measured by the particular locator device over a period of time. If a current signal strength value for any of the locator devices is outside the predetermined range, the central monitoring device may generate a notification and/or alert indicating that a problem may exist with respect to a particular locator device. This may allow personnel to be dispatched to check on issues that may adversely impact the locator devices.

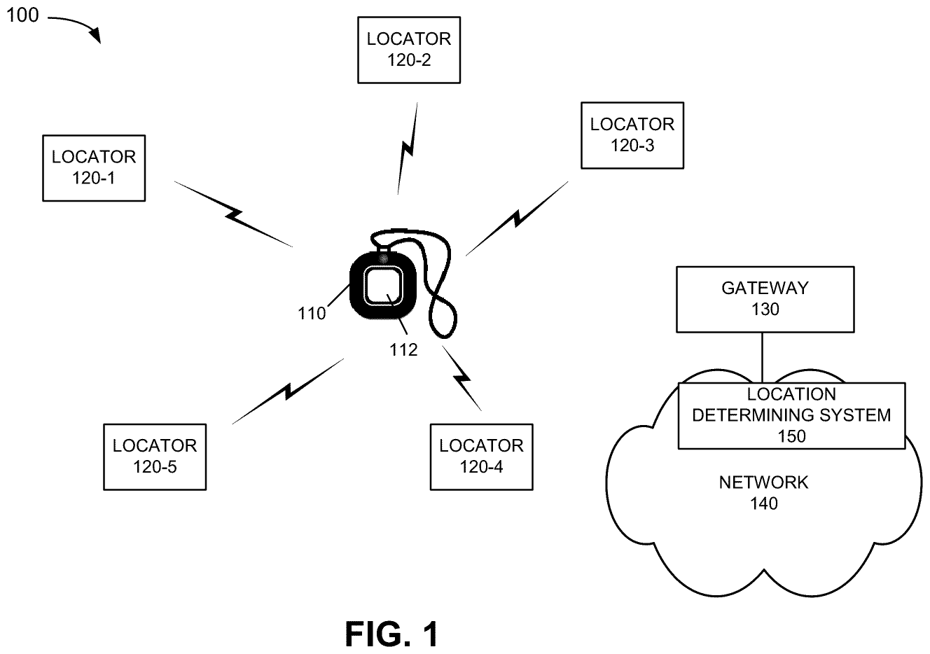

FIG. 1 is a diagram illustrating an exemplary environment 100 in which systems and methods described herein may be implemented. Referring to FIG. 1, environment 100 includes pendant 110, locators 120-1 through 120-5 (also referred to herein as anchors and/or locator devices 120), gateway 130, network 140 and location determining system 150.

Pendant 110 may include a device designed to be worn by a user around the user's neck via a cord, lanyard, necklace or attachment mechanism. In other implementations, pendant 110 may be attached to an article of clothing, such as the user's belt, shirt, blouse, etc. In still other implementations, pendant 110 may be worn on the wrist of the user or be included in a smart watch worn on the user's wrist. In an exemplary implementation, pendant 110 includes a location tracking pendant used to detect a location of the wearer of pendant 110. In another exemplary implementation, pendant 110 may include a fall detection pendant that includes one or more sensors (e.g., an accelerometer) to measure acceleration of pendant 110 and one or more pressure sensors (e.g., a barometric pressure sensor) configured to detect the barometric pressure in the area in which pendant 110 is located. The accelerometer and pressure sensor may be used to detect whether a wearer of pendant 110 has fallen. Pendant 110 may also include a “call button” 112 located on the face of pendant 110. The call button 112 may be pressed and allow the user to establish communications with or send an alert to a system monitored by personnel, such as location determining system 150 and/or an emergency call system (not shown in FIG. 1). In each case, pendant 110 may interface with locators 120 to allow locators 120 to determine the location of the wearer of pendant 110, as described in detail below.

In an exemplary implementation, pendant 110 may also transmit a beacon signal at predetermined intervals that can be received by any locator 120 located within the wireless transmission range of pendant 110. The wireless signal may be transmitted using, for example, Bluetooth (e.g., Bluetooth Low Energy (BLE)) or another wireless protocol, and the wireless signal may include information particularly identifying pendant 110, such as a unique identifier (ID) for pendant 110.

Locators 120-1 through 120-5 (referred to individually as locator 120-X, wherein X is any integer, or locator 120, and referred to collectively as locators 120) may each include a device configured to determine a location associated with pendant 110. For example, each locator 120 may be mounted at a fixed location, such as in a particular room or hallway in a senior or assisted living community, hospital, etc., and may be programmed to store its predetermined location information in an internal memory. In other implementations, location determining system 150 may store the physical location information of locators 120 along with an ID for each locator 120. For example, location determining system 150 may store information indicating that locator 120 with an ID of 12345678 is located in Room 112.

As described above, pendant 110 may transmit a beacon signal, at predetermined intervals, that can be received by any locator 120 located within the wireless transmission range of pendant 110. Locator 120 may receive the signal from pendant 110 and/or other pendants 110 within the wireless range of locator 120 and measure the strength of the received beacon signal. Locator 120 may also receive signals from other locators 120 that include signal strength information associated with the beacon signal received by the other locators 120, as described in detail below. Each locator 120 may then determine whether that locator 120 is located closest to pendant 110 and if so, transmit location information to, for example, location determining system 150, as described in detail below. For example, the signal strength of the received signal is inversely proportional to the distance from the pendant 110 (e.g., inversely proportional to the square of the distance). Therefore, locator 120 receiving the beacon signal having the greatest signal strength will be assumed to be the locator 120 located closest to pendant 110 In some implementations, locator 120 may forward the location information to network 140 via a repeater and/or network coordinator device (not shown) using wired or wireless mechanisms. In each case, a locator 120-X may forward location information regarding pendant 110 when that locator 120-X is the locator located closest to pendant 110.

In accordance with an exemplary implementation, environment 100 may perform testing of locators 120. For example, each locator 120 may transmit a beacon signal or message similar to the beacon signal transmitted by pendant 110. In one implementation, each locator 120 may transmit a beacon message using, for example, BLE or another wireless protocol. The beacon message may include information, in the payload of the message, which indicates the message is a test message. Each locator 120 located within wireless range of the transmitting locator 120 may receive the test message, determine the signal strength of the received test message and send information to location determining system 150. The information may indicate the signal strength of the test message. This signal strength information may be stored in location determining system 150 to identify changes in the signal strength readings. Such changes may indicate a possible problem with respect to a particular locator 120, as described in detail below.

Gateway 130 may include a communication device configured to communicate with various devices in environment 100 via wired or wireless connections. For example, gateway 130 may communicate with locators 120 via wireless or wired connections. Gateway 130 may also be coupled to network 140 via a wired connection or wireless connection (e.g., a cellular connection) to allow information regarding pendants 110 and/or locators 120 to be stored in a location that is remote with respect to other devices in environment 100, such as pendant 110 and locators 120.

Network 140 may include one or more wired, wireless and/or optical networks that are capable of receiving and transmitting data, voice and/or video signals. For example, network 140 may include one or more public switched telephone networks (PSTNs) or other type of switched network. Network 140 may further include one or more satellite networks, one or more packet switched networks, such as an Internet protocol (IP) based network, a software defined network (SDN), a local area network (LAN), a WiFi network, a wide area network (WAN), a Fourth Generation Long Term Evolution (4G LTE) Advanced network, a Fifth Generation (5G) network, a Sixth Generation (6G) network, an intranet, or another type of network that is capable of transmitting data. In one implementation, network 140 may provide packet-switched services and wireless IP connectivity to various components in environment 100 to transmit location related data and/or other data to other devices/systems.

Location determining system 150 may include one or more computer devices having communication, processing and storage capabilities and may be located in or accessible via network 140. Location determining system 150 may receive location data from locators 120 to identify the location of pendants 110 in real time or near real time. This location information may include, for example, a room number, hall number and/or floor number, etc., and enables a party monitoring pendants 110 to track the locations of wearers of pendants 110 in real time or near real time. Location determining system 150 may also receive signal strength information from locators 120 regarding the signal strength of test messages transmitted by locators 120. This information may be used to determine if parameters associated with one or more locators 120 have changed by more than a threshold amount. Such a change may indicate that a locator 120 is possibly experiencing problems, as described in detail below.

In some implementations, location determining system 150 may receive information from a locator 120 that includes a label or other ID associated with the locator 120, along with an ID for the locator 120 from which a test message was received and the corresponding signal strength was measured. In this implementation, location determining system 150 may associate the label/IDs transmitted by locator 120 with information identifying the room, hall number, floor number, etc., associated with the locators 120.

The exemplary configuration illustrated in FIG. 1 is provided for simplicity. It should be understood that a typical environment 100 may include more or fewer devices than illustrated in FIG. 1. For example, environment 100 may include a large number (e.g., hundreds or more) of pendants 110 and locators 120, as well as multiple networks 140 and/or multiple location determining systems 150 distributed in environment 100. The multiple elements may provide redundancy in situations in which a portion of network 140 may be unavailable. Environment 100 may also include signal/message repeater devices, network coordinator devices, one or more emergency call systems and other devices used to facilitate monitoring wearers of pendants 110. Environment 100 may also include other network elements or devices, such as routers, switches, monitoring devices, network elements/functions, etc. (not shown), that aid in routing and transporting data in environment 100.

Various functions are described below as being performed by particular components in environment 100. In other implementations, various functions described as being performed by one device may be performed by another device or multiple other devices, and/or various functions described as being performed by multiple devices may be combined and performed by a single device. For example, in some implementations, the functions of repeater and network coordinator 140 may be combined in a single device.

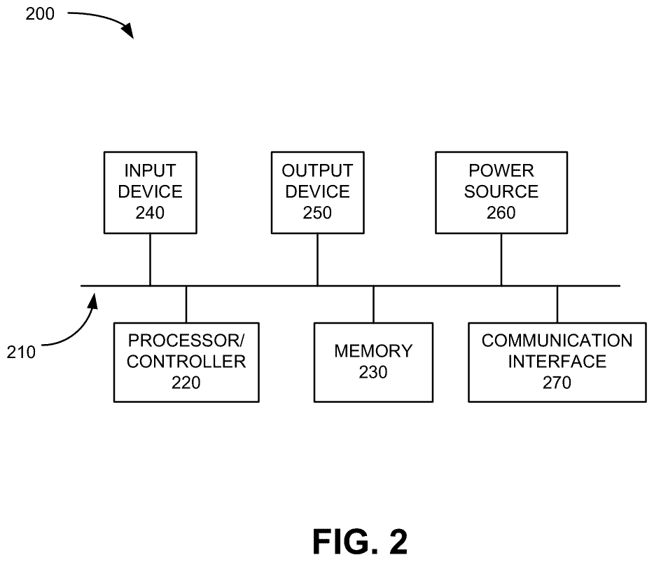

FIG. 2 illustrates an exemplary configuration of a device 200. One or more devices 200 may correspond to or be included in pendant 110, locator 120, location determining system 150 and/or other devices included in environment 100. Referring to FIG. 2, device 200 may include bus 210, processor/controller 220, memory 230, input device 240, output device 250, power source 260 and communication interface 270. The exemplary configuration illustrated in FIG. 2 is provided for simplicity. It should be understood that device 200 may include more or fewer components than illustrated in FIG. 2.

Bus 210 may include a path that permits communication among the elements of device 200. Processor/controller 220 (also referred to herein as processor 220, controller 220 and/or processing logic 220) may include one or more processors, microprocessors, or processing logic that may interpret and execute instructions. Memory 230 may include a random access memory (RAM) or another type of dynamic storage device that may store information and instructions for execution by processor 220. Memory 230 may also include a read only memory (ROM) device or another type of static storage device that stores static information and instructions for use by processor 220. Memory 230 may further include a solid state drive (SSD). Memory 230 may also include a magnetic and/or optical recording medium (e.g., a hard disk) and its corresponding drive.

Input device 240 may include a mechanism that permits a user to input information, such as an input button, a keypad, a keyboard, a mouse, a pen, a microphone, a touch screen, voice recognition and/or biometric mechanisms, etc. Output device 250 may include a mechanism that outputs information to the user, including a display (e.g., a liquid crystal display (LCD)), a speaker, etc. In some implementations, device 200 may include a touch screen display may act as both an input device 240 and an output device 250. Power source 260 may include a battery or other electrical power source for supplying power to device 200.

Communication interface 270 may include one or more transmitters, receivers and/or transceivers that device 200 uses to communicate with other devices via wired, wireless or optical mechanisms. For example, communication interface 270 may include one or more radio frequency (RF) transmitters, receivers and/or transceivers and one or more antennas for transmitting and receiving RF data. For example, when implemented in locator 120, communication interface 270 may include one or more RF transmitters, receivers and/or transceivers and one or more antennas for transmitting and receiving data via a relatively short range RF link and one or more antennas for transmitting and receiving RF data via a longer range connection (e.g., a cellular connection with network 140). Communication interface 270 may also include a modem or an Ethernet interface to a LAN, or other mechanisms for communicating with elements in a network, such as network 140.

Communication interface 270 may operate in accordance with one or more communication standards and may include various processing logic and/or circuitry (e.g., multiplexing/de-multiplexing, filtering, amplifying, converting, error correction, etc.)

In an exemplary implementation, device 200 performs operations in response to processor 220 executing sequences of instructions contained in a computer-readable medium, such as memory 230. A computer-readable medium may be defined as a physical or logical memory device. The software instructions may be read into memory 230 from another computer-readable medium (e.g., a hard disk drive (HDD), SSD, etc.), or from another device via communication interface 270. Alternatively, hard-wired circuitry may be used in place of or in combination with software instructions to implement processes consistent with the implementations described herein. Thus, implementations described herein are not limited to any specific combination of hardware circuitry and software.

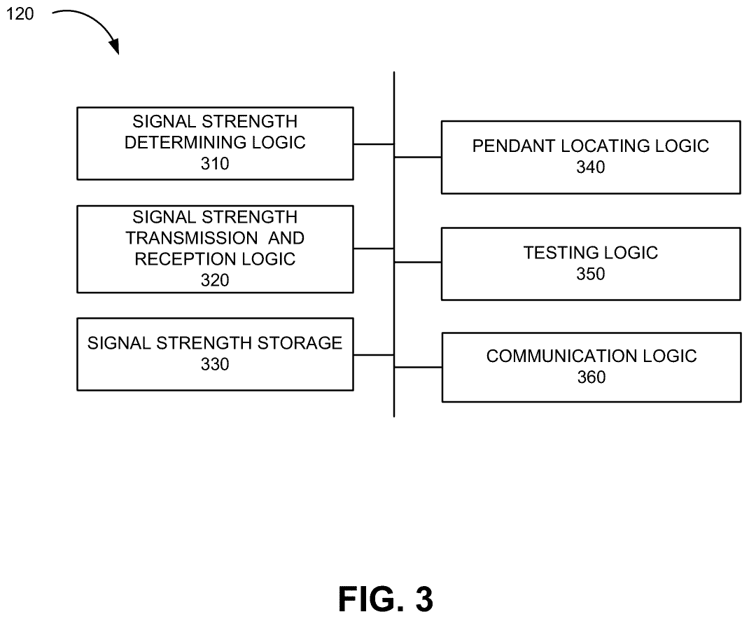

FIG. 3 is a block diagram illustrating exemplary components implemented in locator 120. In an exemplary implementation, some of the components illustrated in FIG. 3 may be implemented by processor 220 executing instructions stored in memory 230.

Referring to FIG. 3, locator 120 includes signal strength determining logic 310, signal strength transmission and reception logic 320, signal strength storage 330, pendant locating logic 340, testing logic 350 and communication logic 350. Signal strength determining logic 310 may include logic configured to receive beacon signals transmitted by pendant 110 and determine the corresponding signal strength of the received signals. For example, signal strength determining logic 310 may receive a beacon signal transmitted by pendant 110 and determine a received signal strength indicator (RSSI) value in decibel milliwatts (dBm) corresponding to the signal strength of the beacon signal received by locator 120. This signal strength information may be stored and forwarded to other locators 120, as described in detail below.

Signal strength transmission and reception logic 320 may include logic to transmit, for example, RSSI information generated by signal strength determining logic 310, along with an identifier (ID) of the transmitting locator 120 and an ID of pendant 110. In an exemplary implementation, signal strength transmission and reception logic 320 may transmit the measured RSSI information a predetermined period of time after the beacon signal is received or after the RSSI information is determined. For example, signal strength transmission and reception logic 320 may transmit the RSSI information at a regular time interval, a pseudo-random time interval or a random time interval after the beacon signal is received, along with the ID of locator 120 and the ID of pendant 110. Signal strength transmission and reception logic 320 may transmit the message including the RSSI information using, for example, BLE protocol similar to the BLE protocol used by pendant 110. Using BLE protocol may also avoid locators 120 having to exchange messages to pair with each other in order to exchange information. That is, any locator 120 in wireless range of another locator 120 may receive the message with the RSSI information. Further, using BLE protocol may avoid interference with other devices that may be using a different frequency band/protocol with respect to communications in environment 100. Signal strength transmission and reception logic 320 may also include logic to receive RSSI information transmitted by the other locators 120 at regular or different time intervals (e.g., pseudo-random or random time intervals), along with the IDs of the other locators 120 and the ID of pendant 110.

Signal strength storage 330 may include a memory to store signal strength information generated by signal strength determining logic 310, as well as signal strength information associated with other locators 120 received by signal strength transmission and reception logic 320. For example, signal strength storage 330 may store RSSI information received by locator 120 from other locators 120 that received the beacon signal from pendant 110. This information may be used to identify the locator 120 located closest to pendant 110 at the particular time.

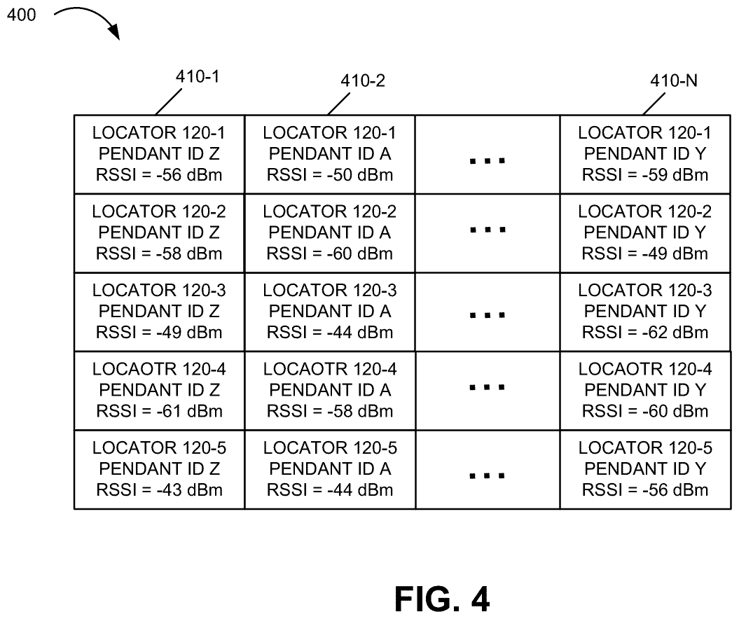

For example, FIG. 4 illustrates an exemplary table 400 stored in signal strength storage 330. Referring to FIG. 4, table 400 includes columns 410-1 through 410-N, with each column storing signal strength information regarding a particular pendant 110. It should be understood that table 400 may include additional columns and/or rows based on, for example, the number of pendants 110 and/or locators 120 in environment 100. For example, each entry in column 410 corresponds to a locator 120 that received a beacon signal from a pendant 110 and communicated that information to locator 120-1.

As described above, each column 410 in table 400 corresponds to RSSI data associated with a particular pendant 110. For example, column 410-1 is associated with a pendant with a pendant ID of Z (referred to as pendant 110-Z). Column 410-1 indicates that locator 120-1 measured the RSSI of the beacon signal transmitted by pendant 110-Z and received by locator 120-1 to be −56 dBm. Column 410-1 also indicates that locators 120-2 through 120-5 received the beacon signal and measured the signal strength of the beacon signal transmitted by pendant 110-Z to be −58 dBm, −49 dBm, −61 dBm and −43 dBm, respectively. Table 400 may similarly store RSSI information associated with other pendants 110 in other columns 410 of table 400. For example, column 410-2 stores RSSI values associated with a pendant 110 with a pendant ID of A and column 410-N stores RSSI values associated with a pendant 110 with a pendant ID of Y.

Pendant locating logic 340 may include logic to determine which locator 120 in environment 100 is located closest to pendant 110 at a particular time. For example, pendant locating logic 340 may compare signal strength information stored in each column in signal strength storage 330 to identify the locator 120 located closest to pendant 110 based on the RSSI values. For example, in table 400 at column 410-1, pendant locating logic 340 may determine that locator 120-5 has an RSSI value of −43 dBm, which corresponds to the greatest RSSI value for pendant 110-Z. Pendant locating logic 340 for locator 120-1 may then determine that locator 120-1 did not receive the beacon signal with the greatest signal strength for pendant 110, indicating that locator 120-1 is not the locator 120 located closest to pendant 110-Z. That is, locator 120-5 received the beacon signal with the greatest strength and pendant locating logic 340 may determine that locator 120-5 is located closest to pendant 110 at the current time. In this case, pendant locating logic 340 may determine that locator 120-1 will not transmit location information regarding the location of pendant 110-Z since locator 120-1 is not located closest to pendant 110-Z. In this example, locator 120-5 will transit its location information. However, in situations in which locator 120-1, for example, is the locator 120 located closest to a pendant 110, pendant location logic 340 for locator 120-1 will transmit its location to, for example, location determining system 150, as described in detail below. In this manner, pendant locating logic 340 acts to arbitrate among locators 120 to identify the locator 120 with the highest signal strength.

Testing logic 350 may include logic to perform a test of locator 120. For example, in one implementation, testing logic 350 may generate a test message every predetermined period of time, plus or minus some random offset period of time. Testing logic 350 may transmit the test message using, for example, BLE protocol similar to that used by pendant 110 or another wireless protocol. The test message may include information, in its payload, which indicates that the message is a test message.

Locators 120 located within wireless range of a locator 120 transmitting the test message may receive the test message and determine the signal strength of the received test message. For example, locator 120-1 may transmit a test message and locators 120-2 through 120-5 may receive the test message. Locators 120-2 through 120-5 may each measure the signal strength of the received test message, and then transmit the determined signal strength to location determining system 150, as described in detail below. Location determining system 150 may store signal strength values over time and determine whether a problem may exist with respect to any of the locators 120. For example, since each locator 120 is installed at a fixed location, the received signal strength values associated with test messages transmitted by one locator 120 and received by other locators 120 should be relatively consistent, plus or minus a certain degree of variance. Location determining system 150 may use the received RSSI values over time to determine if an anomaly exists with respect to a received RSSI value, which may indicate a problem with a particular locator 120, as described in detail below.

Communication logic 360 may include logic for communicating with devices in environment 100. For example, communication logic 360 may transmit data to and receive data from other locators 120, location determining system 150 and/or other devices in environment 100 via wired, wireless or optical mechanisms.

Although FIG. 3 shows exemplary components of locator 120, in other implementations, locator 120 may include fewer components, different components, differently arranged components, or additional components than depicted in FIG. 3. In addition, functions described as being performed by one of the components in FIG. 3 may alternatively be performed by another one or more of the components of locator 120.

As described above, locator 120 may identify signal strength values of beacon signals transmitted by pendants 110. The locator 120 located closest to one of pendants 110 may then transmit its location information to a central monitoring facility. Locator 120 may also identify signal strength values of test messages transmitted by other locators 120 and transmit the signal strength information to location determining system 150. This information may be used to detect potential problems with locators 120, as described in detail below.

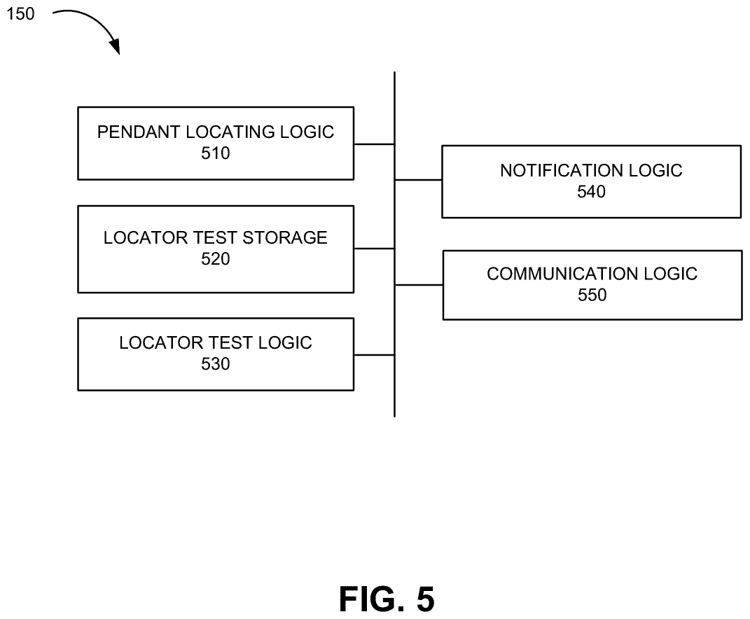

FIG. 5 is a block diagram illustrating exemplary components implemented in location determining system 150. In an exemplary implementation, some of the components illustrated in FIG. 5 may be implemented by processor 220 executing instructions stored in memory 230.

Referring to FIG. 5, location determining system 150 includes pendant location logic 510, locator test storage 520, locator test logic 530, notification logic 540 and communication logic 550. Pendant locating logic 510 may receive messages from one of locators 120 when that locator 120 is located closest to pendant 110. In this manner, location determining system 150 may determine a current location of a pendant 110.

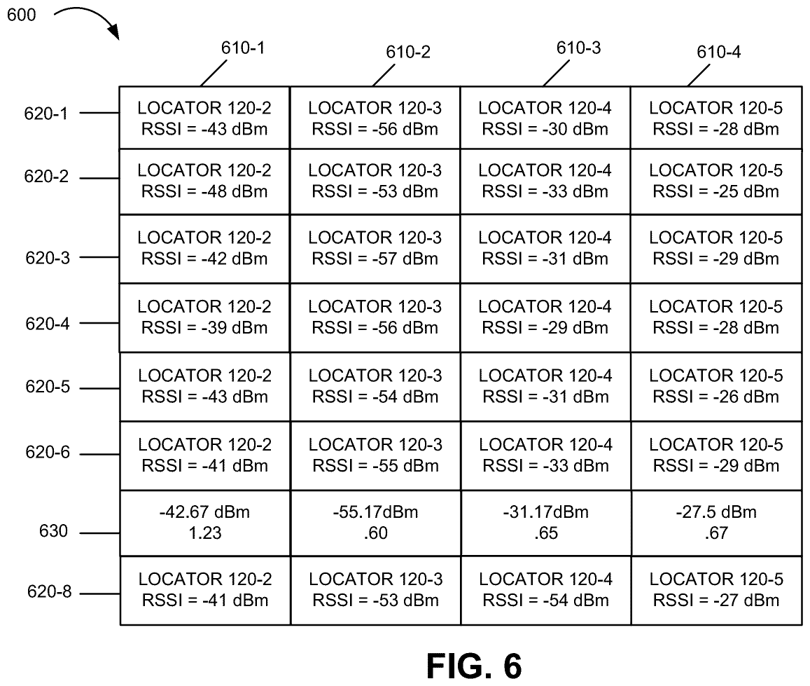

Locator test storage 520 may store signal strength information transmitted by locators 120 and received by location determining system 150. For example, FIG. 6 illustrates an exemplary table 600 stored in locator test storage 520. Referring to FIG. 6, table 600 includes columns 610-1 through 610-4. Each column 610 stores RSSI values associated with data associated with a particular locator 120 and measured by another locator 120 that received the test message from the particular locator 120. For example, assume that table 600 is associated with test messages transmitted by locator 120-1 and received by locators 120-2 through 120-5. For example, column 610-1 stores data associated with test messages transmitted by locator 120-1 over a period of time and received/measured by locator 120-2, column 610-2 stores associated with test messages transmitted by locator 120-1 over the period of time and received/measured by locator 120-3, column 610-3 is associated with test messages transmitted by locator 120-1 over the period of time and received/measured by locator 120-4 and column 620-4 is associated with test messages transmitted by locator 120-1 over the period of time and received/measured by locator 120-5. It should be understood that table 600 may include additional columns 610 based on the number of locators 120 in environment 100 that received a test message from another locator 120.

Each row 620 in table 600 represents RSSI values measured at a particular time. For example, row 620-1 may store RSSI values measured by locators 120-2 through 120-5 taken on Aug. 1, 2023 at approximately 2:00 PM. Row 620-1 may store RSSI values measured by locators 120-2 through 120-5 on the next day at approximately the same time (e.g., Aug. 2, 2023 at 2:00 PM), etc. In this manner, table 600 stores RSSI values associated with test message received and measured over a period of time. For example, rows 620-1 through 620-6 represent six days of test messages sent by locator 120-1 and received by locators 120-2 through 120-5.

Table 600 may also include, for example, a running mean and standard deviation associated with the RSSI values in each column 610. For example, locator test logic 530 may calculate a current mean and standard deviation for the RSSI values in column 610 on a running basis. As an example, the current mean associated with the values in column 610-1 stored in rows 620-1 through 620-6 is −42.67 dBm and the current standard deviation is 1.23. Locator test logic 530 may generate and store the mean and standard deviation in row 630 for each locator 120 (i.e., locators 120-2 through 120-5) and update the mean and standard deviation on a continuous/running basis or on a periodic basis. Locator test logic 530 may also determine whether a current RSSI value associated with a particular locator 120 indicates whether a current RSSI value is not within a predetermined threshold of the other values, such as whether the current RSSI value is within a predetermined range of the mean and/or standard deviation stored in row 630, which may indicate a possible problem associated with a particular locator 120.

For example, in accordance with one implementation, locator test logic 530 may compare a current reading in each of columns 610 to the calculated mean value plus or minus two times the standard deviation for the RSSI values for that locator 120. For example, referring to column 610-1 associated with locator 120-2, the current mean associated with the received signal strength of a test message transmitted by locator 120-1 and received by locator 120-2 is −42.67 dBm and the current standard deviation is 1.23. In this case, locator test logic 530 may determine that an acceptable range for the RSSI value measured by locator 120-2 is −45.13 to −40.21 (i.e., −42.67 plus/minus two times 1.23). In this example, the current reading of −41 dBm (stored in column 610-1 at row 620-8) is within the acceptable range. In other implementations, other thresholds may be determined based on the mean, standard deviation and/or other statistical analysis of the RSSI values. In each case, locator test logic 530 may signal notification logic 540 when a current reading is not within an acceptable range.

Notification logic 540 may include logic to generate a message or alert when a current locator RSSI value is not within an acceptable range. For example, notification logic 540 may generate an alert or message for transmission to a monitoring station within environment 100 and/or to personnel to perform a check associated with a particular locator 120 when a current RSSI value is not within a predetermined range associated with the mean and/or standard deviation, as described in more detail below.

Communication logic 550 may include logic for communicating with devices in environment 100. For example, communication logic 550 may transmit data to and receive data from various devices in environment 100 via wired, wireless or optical mechanisms.

Although FIG. 5 shows exemplary components of location determining system 150, in other implementations, location determining system 150 may include fewer components, different components, differently arranged components, or additional components than depicted in FIG. 5. In addition, functions described as being performed by one of the components in FIG. 5 may alternatively be performed by another one or more of the components of location determining system 150.

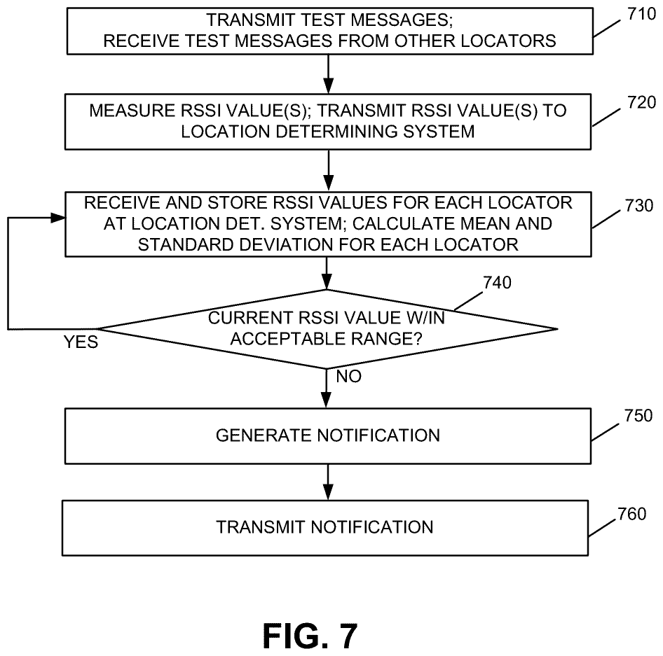

FIG. 7 is a flow diagram illustrating processing associated with environment 100 in accordance with an exemplary implementation. Processing may begin with locators 120 each transmitting a test message at predetermined intervals, plus or minus some random offset (block 710). For example, each locator 120 may transmit a test message once a day or at some shorter or longer interval of time (e.g., every eight hours, every two days, etc.) plus/minus a random offset. The random offset may be used to ensure that each locator 120 does not transmit its test message at the same time as other locators 120, which may help avoid data collisions between the test messages. As described above, each locator 120 may transit the test message using, for example, a BLE protocol, and the test message may include a payload indicating that the message is a test message along with an ID associated with the particular locator 120 transmitting the test message.

Each locator 120 may also receive the test messages from other locators 120 located within wireless range of that particular locator 120 (block 710). For example, locator 120-1 may receive test messages from locators 120-2 through 120-5. Similarly, locators 120-2 through 120-5 may receive test messages from each other locators 120-1 through 120-5 within wireless range. Signal strength determining logic 310 of each locator 120 may determine the signal strength of the received test messages, such as measure the RSSI in dBm (block 720). Each locator 120 may also transmit the measured RSSI values associated with each received test message, along with an ID of the locator 120 from which the test message was transmitted and the ID of the locator 120 receiving the test message, to location determining system 150 (block 720).

Location determining system 150 may receive the messages from locators 120 including the RSSI values and IDs of the receiving and transmitting locators 120 associated with each RSSI value, and store the RSSI values (block 730). For example, location determining system 150 may store the RSSI values in locator test storage 520. As described above, locator test storage 520 may include a table 600 for each particular locator 120 transmitting a test message. For example, table 600 described above with respect to FIG. 6 illustrates RSSI values for a test message transmitted by locator 120-1 and received by locators 120-2 through 120-5. Locator test storage 520 may include similar tables associated with test messages transmitted by locators 120-2 through 120-5.

Location determining system 150 may calculate the mean and standard deviation for each locator 120 that received the test message (block 730). For example, locator test logic 530 may calculate the mean for the RSSI values associated with test messages from locator 120-1 and received by locators 120-2 included in column 610-1. In this example, locator test logic 530 determines that the mean for test messages transmitted by locator 120-1 and received by locator 120-2 is −42.67 dBm and the standard deviation is 1.23, as indicated in row 630 of column 610-1.

Location determining system 150 may then determine whether the current RSSI value for each locator 120 in table 600 is within an acceptable range (block 740). For example, in one implementation, the acceptable range may be the mean plus or minus two standard deviations. As discussed above for locator 120-2, the acceptable range in this example is −45.13 dBm to −40.21 dBm (i.e., −42.67 plus/minus two times 1.23). Continuing with this example, the current or most recent RSSI value received from locator 120-2 in column 610-1 at row 620-8 is −41 dBm, which is within the acceptable range of −45.13 to −40.21. If locator test logic 430 determines that the current RSSI value is within the acceptable range (block 740—yes), location determining system 150 may return to block 730 and calculate the current mean and standard deviation for the next locator 120 and determine if the current value is within the acceptable range.

For example, locator test logic 530 may calculate the mean and standard deviation for locator 120-4 to be −31.17 dBm and 0.65, respectively. In this example, assume that the current value for locator 120-4 in row 620-8 at column 610-3 is −54 dBm. In this case, the current value of −54 is not within the acceptable range of −32.47 dBm to −29.87 dBm, and locator test logic 530 determines that the current RSSI value is not within the acceptable range (block 740—no).

Locator test logic 530 may signal notification logic 540 to generate a notification message or alert regarding locator 120-4. For example, notification logic 540 may generate a message indicating that the signal strength value for locator 120-4 is not within the acceptable range, which indicates that there may be a problem with respect to locator 120-4 (block 750). Notification logic 540 may then transmit the notification message via communication logic 550 (block 760). For example, notification logic 540 may transmit a notification message/alert to a system associated with monitoring locators 120 and/or pendants 110, transmit a notification message/alert (e.g., a text message, email, etc.) to personnel associated with monitoring locators 120 and/or pendants 110, etc.

In some implementations, location determining system 150 may use the current signal strength value along with historical data regarding signal strengths to provide additional information on the type of possible problem. For example, if the current signal strength value is significantly outside the predetermined threshold, location determining system 150 may determine that a locator 120 has a weak or dead battery, is obstructed by a piece of furniture, has been dislodged from its normal location, etc. Further, in some implementations, historical data may be used to determine if a current signal strength value or change in signal strength values is expected based on the historical data. For example, if during certain periods of a day, there is an expected and/or acceptable change in the environment in which a locator 120 is located, a lower signal strength value measured by that particular locator 120 may be acceptable. In some implementations, the historical data may be analyzed by, for example, a machine learning algorithm or another algorithm to identify periodic and/or acceptable changes in signal strength values that otherwise would be outside the acceptable range. In this manner, historical data and/or information associated with prior problems regarding locators 120 may be used to provide information regarding a possible type of problem and/or determine that no problem exists.

In other implementations, block 760 may be bypassed and location determining system 150 may store the notification/indication that a signal strength reading for a particular locator 120 is not within the acceptable range. In such implementations, personnel associated with monitoring locators 120 and/or pendants 110 may access location determining system 150 to view any alerts/notifications.

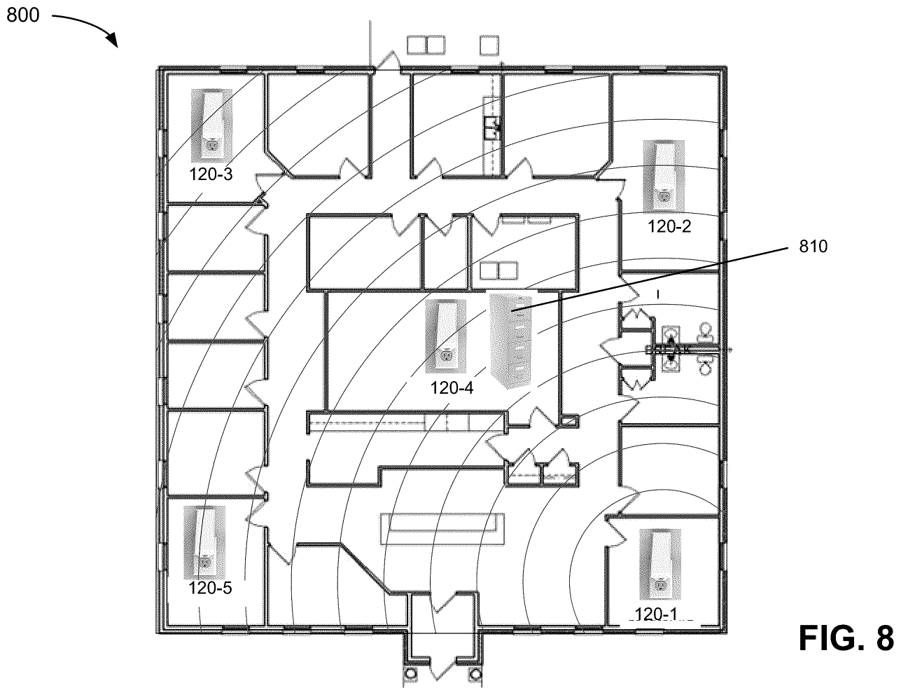

In each case, locators 120 may be monitored for possible problems. For example, FIG. 8 illustrates an environment 800 in which a particular locator 120 may be compromised. Referring to FIG. 8, a filing cabinet 810 is located near locator 120-4. In this case, when locator 120-1 transmits its test message, filing cabinet 810 may block some of the signal from reaching locator 120-4. As a result, locator 120-4 may measure a reduced signal strength, such as −54 dBm as illustrated in row 620-8 of table 600. Since this RSSI value is outside the range of the mean plus/minus two standard deviations (e.g., −31.17 dBm plus/minus 1.3 shown in row 630 at column 610-3 for locator 120-4), location determining system 150 may generate and/or transmit a notification/alert. In this case, personnel associated with monitoring environment 800 may go to the room in which locator 120 is located, identify that the filing cabinet 810 is obstructing the ability of locator 120-4 to receive RF signals, including signals from wearers of pendants 110, which may result in incorrect location determinations associated with pendants 110. The personnel may then move the filing cabinet 810 and/or re-locate locator 120-4 to an area that is not obstructed by filing cabinet 810. In this manner, testing initiated by locators 120 may improve the overall accuracy with respect to identifying the location of pendants 110 by addressing anomalies associated with RSSI values measured by locators 120. In other implementations, personnel may determine that a particular locator 120 is not working, has a low battery or another problem. In each case, personnel may alerted in real time to possible problems without having to visually inspect and test each locator 120.

Implementations described herein provide for testing of locator devices in an automated manner by transmitting test messages from locators 120 at predetermined intervals and reporting signal strength values measured by other locator devices that receive the test messages. In this manner, signal strength values measured by a particular locator 120 may identify a possible problem, and an alert may be generated to inform other systems and/or personnel of the potential problem. This may also allow personnel to address the potential problem in real time and ensure that all locators 120 are operating properly, not obstructed, etc.

The foregoing description of exemplary implementations provides illustration and description, but is not intended to be exhaustive or to limit the embodiments to the precise form disclosed. Modifications and variations are possible in light of the above teachings or may be acquired from practice of the embodiments.

For example, features have been mainly described with respect to measuring the mean and standard deviation of signal strength values and determining if the current measurement is within an acceptable range based on the mean and standard deviation. In other implementations, other statistical measurements and/or formulas may be used to determine if a current signal strength value is within an acceptable range or whether the current signal strength value indicates that a problem may exist with respect to one or more locators 120.

In addition, features have been described above with respect to transmitting test messages from one locator 120 to other locators 120. In some implementations, each locator 120 may transmit the test message multiple times over a short duration to ensure that at least one of the transmissions is received by one or more other locators 120. Further, in some implementations, each locator 120 may transmit the test message multiple times via different channels using different frequencies. Using different channels/frequencies for the transmissions may make it more likely that at least one of the test messages will be received by another locator 120.

Further, features have been described above mainly with respect to locators 120 transmitting information to location determining system 150 wirelessly. In other implementations, locators 120 may communicate with location determining system 150 via a wired backhaul medium.

Still further, features described herein may be implemented in an environment which uses a same network medium for transmitting beacon signals and transmitting test messages between locators 120. In other implementation, locators 120 may use a different network medium to transmit test messages to other locators 120 than the network medium used for the beaconing and backhaul in environment 100.

In addition, features have been described above with respect to testing locators used to track pendant locations in a real time location system that employs BLE beacons. It should be understood that implementations described herein may also be used in other real time locations systems or non-real time locations systems that employ locator devices to track the locations of pendants or other devices.

Further, while series of acts have been described with respect to FIG. 7, the order of the acts may be different in other implementations. Moreover, non-dependent acts may be implemented in parallel.

It will be apparent that various features described above may be implemented in many different forms of software, firmware, and hardware in the implementations illustrated in the figures. The actual software code or specialized control hardware used to implement the various features is not limiting. Thus, the operation and behavior of the features were described without reference to the specific software code—it being understood that one of ordinary skill in the art would be able to design software and control hardware to implement the various features based on the description herein.

Further, certain portions of the invention may be implemented as “logic” that performs one or more functions. This logic may include hardware, such as one or more processors, microprocessor, application specific integrated circuits, field programmable gate arrays or other processing logic, software, or a combination of hardware and software.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

No element, act, or instruction used in the description of the present application should be construed as critical or essential to the invention unless explicitly described as such. Also, as used herein, the article “a” is intended to include one or more items. Further, the phrase “based on” is intended to mean “based, at least in part, on” unless explicitly stated otherwise.

What is claimed is:

1. A device, comprising:
a communication interface; and
processing logic configured to:
receive messages from each of a plurality locator devices, wherein each of the messages includes a signal strength value associated with a test message transmitted by an other one of the plurality of locator devices, and
determine whether a current signal strength value received in a message from a first one of the plurality of locator devices is within a predetermined range associated with signal strength values included in messages received from the first locator device.

2. The device of claim 1, wherein the processing logic is further configured to:
generate, in response to determining that the current signal strength value is not within the predetermined range, a notification associated with the first locator device.

3. The device of claim 2, wherein the processing logic is further configured to:
transmit, via the communication interface, the notification to a system for monitoring the plurality of locator devices, wherein the notification includes information indicating a problem associated with the first locator device.

4. The device of claim 1, wherein the processing logic is further configured to:
determine, for each of the plurality of locator devices, at least one of a mean or standard deviation associated with the signal strength values included in the messages received over a period of time.

5. The device of claim 4, wherein when determining at least one of the mean or standard deviation, the processing logic is configured to:
determine the mean of a plurality of signal strength values for each of the plurality of locator devices, and
determine the standard deviation of the plurality of signal strength values for each of the plurality of locator devices.

6. The device of claim 5, wherein the processing logic is further configured to:
determine the predetermined range for each of the plurality of locator devices based on the mean and the standard deviation.

7. The device of claim 1, further comprising:
a memory configured to store a plurality of signal strength values for each of the plurality of locator devices, and
wherein the processing logic is configured to:
determine at least one of a mean, standard deviation or the predetermined range associated with signal strength values for each of the plurality of locator devices, and
store, in the memory, the at least one of the mean, standard deviation or the predetermined range for each of the plurality of locator devices.

8. The device of claim 1, wherein each of the received messages includes an identifier (ID) associated with the locator device that transmitted the message to the device, and an ID of another one of the locator devices that transmitted the test message.

9. The device of claim 1, wherein each of the plurality of locator devices is configured to track locations of a plurality of pendants worn or carried by users.

10. A system, comprising:
a plurality of locator devices; and
a network device configured to receive information from the plurality of locator devices, wherein each of the plurality of locator devices comprises:
a communication interface, and
first processing logic configured to:
transmit a test message at predetermined times,
receive, via the communication interface and from other ones of the plurality of locator devices, other test messages,
determine a signal strength value for each of the received other test messages, and
transmit, to the network device, messages including the determined signal strength values.

11. The system of claim 10, wherein the network device includes second processing logic configured to:
receive the messages from each of a plurality locator devices, and
determine whether a signal strength value in a current one of the messages received from a first one of the plurality of locator devices is within a predetermined range associated with signal strength values in messages received from the first locator device over a period of time.

12. The system of claim 11, wherein the second processing logic is further configured to:
generate, in response to determining that the current signal strength value is not within the predetermined range, a notification associated with the first locator device, wherein the notification message includes information indicating a possible problem associated with the first locator device.

13. The system of claim 12, wherein the second processing logic is further configured to:
transmit the notification to a system or personnel that monitor the plurality of locator devices, wherein the notification includes information indicating a problem associated with the first locator device.

14. The system of claim 10, wherein the network device includes second processing logic configured to:
receive the messages transmitted by each of the plurality of locator devices, and
determine, for each of the plurality of locator devices, at least one of a mean or standard deviation associated with the signal strength values included in the received messages.

15. The system of claim 14, wherein the second processing logic is configured to:
determine whether a current signal strength value for a first one of the plurality of locator devices is within a predetermined range of other ones of the signal strength values for the first locator device based on at least one of the mean or standard deviation.

16. The system of claim 10, wherein the network device further comprises:
a memory configured to store a plurality of signal strength values for each of the plurality of locator devices, and
second processing logic configured to:
determine at least one of a mean, standard deviation or a predetermined range associated with signal strength values for each of the plurality of locator devices, and
store, in the memory, the at least one of the mean, standard deviation or the predetermined range for each of the plurality of locator devices.

17. The system of claim 10, wherein the test message includes an identifier (ID) associated with the locator device that transmitted the test message, and
wherein the messages transmitted to the network device include the ID associated with the locator device that transmitted the test message and an ID of the locator device that transmitted the message to the network device.

18. The system of claim 10, wherein each of the plurality of locator devices is configured to track locations of a plurality of pendants worn or carried by users.

19. A locator device, comprising:
a communication interface; and
processing logic configured to:
receive beacon messages transmitted by a plurality of pendants worn or carried by users,
transmit a test message at predetermined times,
receive, via the communication interface and from other ones of a plurality of locator devices, other test messages,
determine a signal strength value of the received other test messages, and
transmit, via the communication interface and to a network device, messages including the determined signal strength values.

20. The locator device of claim 19, wherein each of the messages transmitted by the locator device include an identifier (ID) associated with the locator device and an ID associated with one of the plurality of locator devices that transmitted one of the other test messages.

21. A method, comprising:
transmitting, by each of a plurality of locator devices and at predetermined times, a test message;
receiving, by each of the plurality of locator devices, other test messages from other ones of the plurality of locator devices;
determining, by each of the plurality of locator devices, a signal strength value for each of the received other test messages;
transmitting, by each of the plurality of locator devices and to a network device, messages including the determined signal strength values for each of the received other test messages;
receiving, by the network device, the messages from each of the plurality locator devices; and
determining, by the network device, whether a signal strength value in a current one of the messages received from a first one of the plurality of locator devices is within a predetermined range associated with signal strength values included in messages received from the first locator device over a period of time.
